(19) United States
(12) Patent Application Publication
(10) Pub. No.: US 2025/0134314 A1
(43) Pub. Date: May 1, 2025

(54) FROTHER FOR MILK BASED BEVERAGES

(71) Applicants: Alex GORT-BARTEN, Crawley (GB); Leslie Alexander GORT-BARTEN, Crawley (GB)

(72) Inventors: Alex GORT-BARTEN, Crawley (GB); Leslie Alexander GORT-BARTEN, Crawley (GB)

(21) Appl. No.: 18/717,912

(22) PCT Filed: Jan. 6, 2023
(86) PCT No.: PCT/EP2023/050246

§ 371 Date: Jun. 7, 2024

(30) Foreign Application Priority Data
Jan. 7, 2022 (GB) 2200166.3
Aug. 9, 2022 (GB) 2211590.1

(51) Int. Cl. A47J 43/07; A47J 43/046; B01F 27/118; B01F 33/453; B01F 35/90; B01F 35/92; B01F 101/07; B01F 101/12; B01F 101/14

(52) U.S. Cl. CPC A47J 43/0722; A47J 43/0465; B01F 27/118; B01F 33/4534; B01F 35/92; B01F 2035/99; B01F 2101/07; B01F 2101/12; B01F 2101/14

(57) ABSTRACT

A whisk means for a frother for producing a hot chocolate beverage is adapted to rotate in the liquid to mix the heating liquid. The whisk means comprises a whisk comprising a plurality of coils, which whisk is mounted on a support, the whisk means further comprising a basket located above the whisk means, which basket is provided with one or more slots for allowing the heating liquid to melt or dissolve the hot chocolate beverage precursor.

The invention relates to a frother for milk based beverages and to a whisk for a frother.

Espresso based coffee drinks such as caffè latte and cappuccino have become increasingly popular and consumers want to be able to easily and reliably produce these drinks. Traditionally, baristas have been trained to use the steam generated by an espresso machine to heat and froth milk in a jug to produce the hot milk and froth required for these drinks. Producing the appropriate amount of hot milk and froth without burning the milk or damaging the jug requires some training or experience. Smaller espresso machines are also much harder to use to treat the milk.

A number of separate milk frothers have been produced which are suitable for home or small scale commercial use. EP1656866 discloses a frother with a tank to receive a milk-based liquid food with a magnetic beater. A magnetic beater driving system produces a magnetic field which drives the beater in rotation in the tank. The system, beater and a beater positioning unit break or prevent symmetrical circulation of the liquid around a median of vertical axis of the tank. Heating units are disposed in association with the tank for heating the liquid. This is used for preparing foam from a milk-based liquid food product.

GB2454421 discloses a device for frothing milk that is provided with a rotating heating element to be inserted in the milk. The device is provided with a whisk attachment for producing froth and a paddle attachment for producing a more creamy finish.

A further problem with the known frothers is that the milk tends to burn on the element as when the frother has frothed the milk, the user immediately pours the milk out and a small residue remains behind, which burns on the element. If this is not cleaned quickly, the burnt on residue becomes difficult to remove and also affects future performance. The standard approach to this has been to reduce the temperature to which the milk is heated to around 60 C but at this temperature, the frothed milk is not suitable for use in other beverages such as hot chocolate, which would require a higher temperature to be palatable.

Known milk frothers and hot chocolate makers use small DC motors to rotate the whisk. The motor drive shaft can be connected directly to the whisk via a mechanical coupling, or remotely by means of a magnetic coupling. These motors do not have much torque and so stall easily> The magnetic couplings in the motor can also slip and become unphased.

Further problems arise when creating hot chocolate drinks. The load applied to rotate the milk/chocolate mixture within the jar is greater than just milk. Also, the use of chocolate flakes, rather than chocolate powder, puts a greater rotational load on the system. This greater rotational load has two effects; it can cause the whisk motor to stall (or magnetic coupling to slip) or can result in the formation of a smaller vortex If the drive motor stalls or the coupling slips, the user must stop the cycle, reposition the whisk, and start the cycle again. Sometimes it is not possible to start cycle again as chocolate has found its way underneath the whisk, preventing the coupling from connecting again. In this case the user is forced to dispose of the unfinished drink and start again afresh.

Formation of a smaller vortex exposes less (or non) of the whisk to the air. This reduces the amount of air introduced to form froth, creating an undesirable drink consistency of warm chocolate milk rather than a hot chocolate.

GB2486872 represented a significant advance in the art of domestic milk frothers but is limited to use with milk. It is also a single cup design which is the standard capacity in the industry. Designing a milk frother with a higher capacity and suitable for making hot chocolate than the known milk frother designs requires that more power will need to be sent to the motor as the motor may stall or the magnetic drive may disengage. Known whisk designs may not remain stable and/or may wear out too quickly with this increased power.

The present invention therefore seeks to provide a frother that can be used for producing a wider range and volumes of in particular milk based beverages.

According to the invention there is provided whisk means for a frother for producing a beverage comprising a tank for receiving a liquid, which tank has substantially vertical walls and a flat bottom, magnetic drive means adapted to drive whisk means, which whisk means is adapted to rotate in the liquid to mix the heating liquid, the frother further comprising heating means adapted to heat the milk or milk based liquid, the magnetic drive means being located outside of the tank, beneath the flat bottom of the tank, wherein the whisk means comprise a whisk comprising a plurality of coils, which whisk is mounted on a support, the whisk means further comprising a basket located above the whisk means, which basket is provided with one or more slots for allowing the heating liquid to melt or dissolve a beverage precursor.

Preferably the beverage precursor comprises chocolate flakes. Preferably, the basket comprises a plurality of concentric rings spaced from one another.

The whisk design of the invention advantageously basket mechanism that holds the chocolate in the milk frother that stops the motor from stalling and/or the magnetic or similar drive coupling from disengaging. with larger chocolate flakes. Chocolate flakes tend to act like small sticks/shards of glass. These naturally tend to form clumps as their shape helps them interlock. This clump can move around in the jar and position itself against the whisk causing it to stall or the magnetic coupling to slip, before the chocolate has had a chance to soften/melt, whereas in the frother of the invention the flakes melt into the liquid with little movement.

Exemplary embodiments of the invention will now be described in greater detail with reference to the drawings in which:

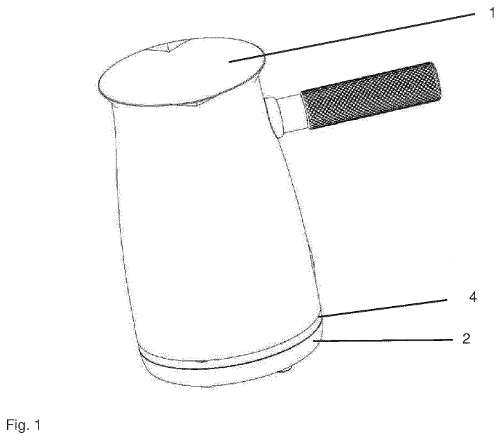

FIG. 1 shows a perspective view of the frother;

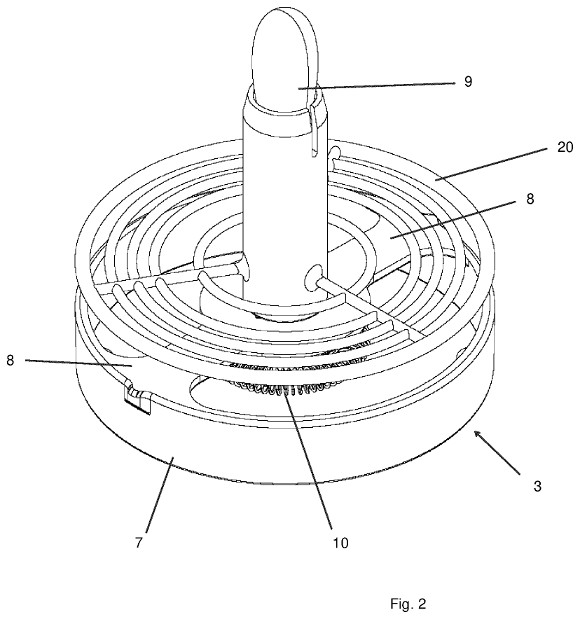

FIG. 2 shows a perspective view of the whisk;

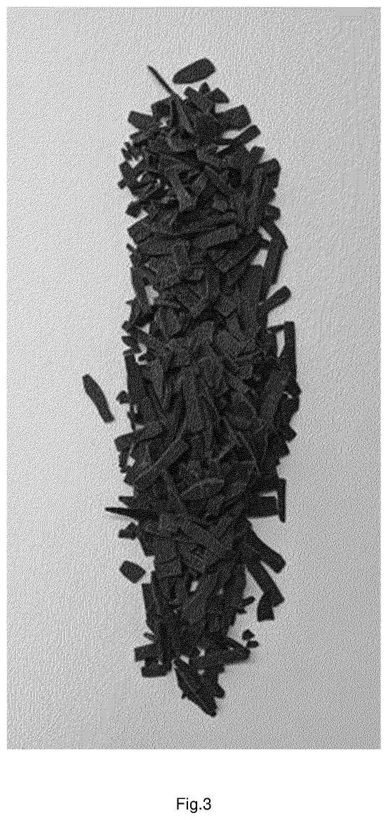

FIG. 3 shows chocolate flakes;

FIG. 4 shows a further whisk design;

FIG. 5 shows a detail of a basket;

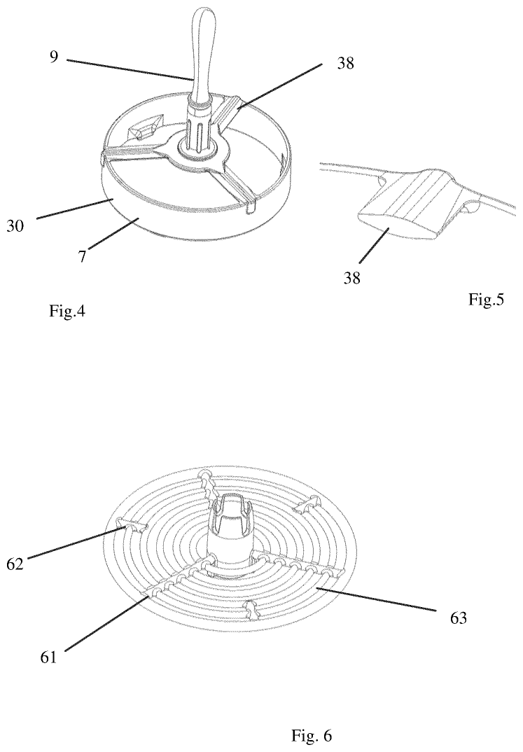

FIG. 6 shows a further whisk design;

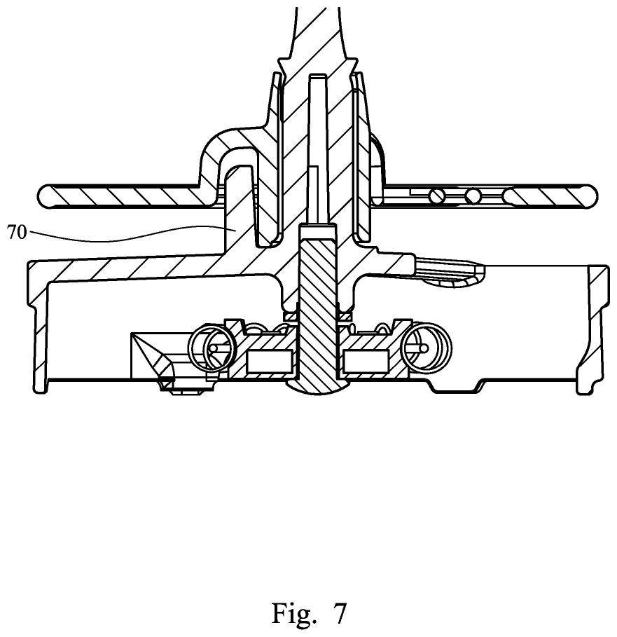

FIG. 7 shows a further whisk design with an upstand.

FIG. 1 shows a perspective view of a milk frother having a tank 1 having a generally circular outer and inner circumference for receiving milk to be frothed and a handle 5. A magnetic drive means 2 is provided below the lower surface of the tank 1, which drive means 2 is adapted to impart a drive to a removeable stirrer or whisk means 3 located in the tank without a mechanical connection member intruding through the wall of the tank 1. The removeable stirrer or whisk means 3 is supported on the base of the tank 1 to ensure that it remains centred and that the drive mechanism can impart drive to the stirrer.

A heating plate 4 is located beneath the base of the tank 1, which heating plate is adapted to heat the milk in use. The frother is provided with control means adapted to control the actuation of the heating plate and also, independently, the actuation of the magnetic drive means. The control means can be either a single ECU or independent PCBs. The magnetic drive means can also have more than one speed so that the liquid is not frothed depending on the beverage to be made. For example follow on baby milk would not be frothed.

In use, the control means are adapted to turn off the heating plate a predetermined time before the stirrer stops stirring so that the residual heat of the plate can be removed by the action of the stirrer passing the milk over it for the predetermined period of time. The length of time will depend on both the dimensions of the tank, the speed of the stirrer and the desired temperature of the milk. An exemplary predetermined length of time is around 10 s. A possible range of times is 6 to 20 s.

This particular arrangement has the attraction of permitting the milk to be heated to a higher temperature than would otherwise be possible but by the time the milk is poured from the frother the base of the tank will have cooled sufficiently that any residual milk that is left in contact with the tank will not burn. For example, in a frother of the invention it is possible to heat the milk to 75 C, which is suitable for making hot chocolate, whereas in most prior art devices, the milk is only heated to around 60 C as any higher temperature would result in unacceptable levels of milk burning on the surface of the frother.

FIG. 2 shows a perspective cross-sectional view of whisk from above in accordance with a first embodiment of the invention, which whisk is suitable for using with large chocolate flakes, examples of which are shown in FIG. 3. The whisk means 3 comprises an upstanding wall 7, which wall is joined by two radial arms 8 to an axial spindle 9. Each of the arms is provided with a cut out in the region of the wall, which cut out receives a clip of a cover to retain the cover in position. The spindle 9 extends above and below the radial arms 8. A whisk 10 is rotatably mounted on a rotatable drive shaft at the lower end of the spindle 9, which drive shaft is housed within the spindle 9. The wall shown is an annular wall but need not be a continuous annular wall.

The whisk is provided with a basket 20. The basket can clip onto the spindle 9 or alternatively be formed integrally with it. In use, the basket needs to stay attached to the whisk means/spindle so that it spins in use and also so that it does not fall off when the drink is poured. The spinning of the basket helps move the flakes outwards and into the milk vortex, aiding mixing. Allowing the basket to rotates helps the vortex form, thus introducing more air into the mixture, creating the froth. The basket is provided with a plurality of slots, which enable fluid to pass into the basket but which around 2-2.5 mm wide. The spinning also reduces the load on the motor/drive couple. The clump of chocolate can spin with the rotating milk, rather than being stationary and acting like a brake

In use the whisk and basket are fitted in the tank and preferably the milk is followed by the chocolate or other beverage precursor. The basket that receives the chocolate flakes in the milk frother prevents the motor from stalling and/or the magnetic or similar drive coupling from disengaging by keeping the chocolate above and away for the rotating whisk. The milk is initially frothed with a slow start below the chocolate. When the milk reaches chocolate melt temperature, the speed can be increased so the height of the milk in the frother increases and then the chocolate begins to melt and mixes into the milk. The basket additionally keeps the chocolate away from the heating plate of the frother, which makes it easier to clean.

The wall of the basket can be optional. Removal of the wall would allow the basket to be slimmer and give more design freedom to adjust the height of the whisk. The height of the basket also effects the amount of froth and chocolate residue left on the whisk. The required height may need to change based on the hot chocolate recipe.

The basket design may be angled up or down as well as the flat version shown in FIG. 2. This adjusts the how the chocolate sits during the frothing cycle, which affects the amount of froth and chocolate residue left on the whisk. Alternatively, the basket can be substantially flat and have no wall. This way it can be reversible to adjust the height.

The spacing of the concentric rings forming the gaps in the basket can be even or uneven, this can be used to control the amount of froth and also to reduce undissolved chocolate residue, that may remain at end of the cycle.

The basket could have 2 or more radial arms that attach the concentric rings to the central shaft, the radial arms could be straight or curved. The cross section of the concentric rings can be circular, diamond, teardrop, to reduce the chance of the undissolved chocolate settling on the basket.

FIG. 4 shows a further whisk design. The whisk 30 of FIG. 4 also comprises an upstanding wall 7, which wall is joined by three radial arms 38 to an axial spindle 9. Each of the arms is provided with a cut out in the region of the wall, which cut out receives a clip of a cover to retain the cover in position. The spindle 9 extends above and below the radial arms 38. A whisk comprising coils, not shown, is rotatably mounted on a rotatable drive shaft at the lower end of the spindle 9, which drive shaft is housed within the spindle 9. The wall shown is an annular wall but again need not be a continuous annular wall.

The use of three arms allows each arm to be made thinner for the same overall strength as with two arms. Each arm may be given an aerofoil style section as shown in FIG. 5 so that drag on the flow of liquid, initially milk but later with cocoa mass, can be reduced. The reduction in drag advantageously leads to the formation of smaller bubbles in the mix improving the organoleptic properties of the drink.

The load on the motor and coupling can become more significant depending on the recipe to be used in the hot chocolate maker, such as increasing the % of chocolate to milk used. In a typical hot chocolate drink around 35 grams of chocolate is used with 220 ml of milk. This would make one serving of hot chocolate. Other recipes might want to use are 35 gram of chocolate and 120 ml of milk to make cold frothed milk or 70 grams of chocolate and 120 ml milk to make a chocolate dipping sauce/pudding.

The embodiment of FIGS. 5 and 6 enables the production of drinks using larger flakes, which have a comparatively reduced surface area. With a reduced surface area, it is harder to get chocolate to melt/dissolve into a set volume of milk in the given time. (with simple controls the time is fixed by volume of milk and how long it takes to heat to 67 degrees).

The lower the resistance on the whisk/drive motor the faster it spins. Therefore if the resistance of the whisk support part is reduced it should spin faster, mixing the milk and chocolate quicker. The extra speed enables the device to act like a blender, breaking down the larger pieces of chocolate so they dissolve more quickly.

As the pieces fall though the basket they get exposed to the sharper leading edge of the support arms (as well as the extra arm compared to the first embodiment) and this helps with the breaking down of the pieces in a controlled way as to not stall the whisk It has been found that the optimum height for basket, relative to the bottom of the jar should be the minimum level of milk required in the recipe. The measurement is taken from the top of the basket.

FIG. 6 shows a further embodiment of the basket. As with the previous embodiment, the basket can clip onto the spindle 9 or alternatively be formed integrally with it. The basket therefore spins in use. The spinning helps move the flakes outwards and into the milk vortex, aiding mixing. In this embodiment the concentric rings 63 are spaced out more closer to the centre of the whisk. The radial arms are also reduced in length in three of the arms 62, which reduced length arms alternate with the full length arms 61 The change in spacing out of the concentric rings closer to the centre of the whisk can reduce the amount of residual chocolate.

The spacing between the rings should be less than the smallest piece of chocolate flakes, so as the diameter of the device increases, more concentric rings may be required and vice versa. More radial arms may be required to be added purely for strength of the basket to support the additional weight of cholate. An exemplary gap between rings is between 4 and 6 mm.

FIG. 7 shows a further embodiment of the invention in which the innermost ring of the basket has been removed. In its place is an upstand 70 that disrupts the flow of the milk in use when the whisk is rotating. The upstand 70 can be formed on the whisk means or on the basket and extends above the height of the basket. The upstand stops the chocolate from collecting or sitting on the basket where, depending on the precursor ingredients, it can start to form clumps after the precursor has started to melt.

Apart from chocolate, other milk based beverage precursors are possible such as honey. Milk can include non dairy milks. A standard hot chocolate recipe comprises 220 ml milk and 35 g chocolate

1. A whisk means for a frother for producing a beverage, the frother comprising a tank for receiving a liquid, magnetic drive means adapted to drive whisk means, which whisk means is adapted to rotate in the liquid to mix the liquid, the frother further comprising heating means adapted to heat the liquid, the magnetic drive means being located outside of the tank, wherein the whisk means comprise a whisk comprising a plurality of coils, which whisk is mounted on a support, the whisk means further comprising a basket located above the whisk means, which basket is provided with one or more slots for allowing the heating liquid to melt or dissolve a beverage precursor.

2. The whisk means according to claim 1, wherein the beverage precursor comprises chocolate flakes, pieces or buttons.

3. The whisk means according to claim 1, wherein the one or more slots are formed by a plurality of concentric rings spaced from one another.

4. The whisk means according to claim 1, wherein each of the one or more slots has edges and the space between opposed edges is between 2 and 6 mm.

5. The whisk means according to claim 3, wherein a cross section of the concentric rings is circular, diamond, or teardrop.

6. The whisk means according to claim 3, wherein the concentric rings are joined by a plurality of radial arms, wherein some radial arms have a first length and some radial arms have a second length.

7. The whisk means according to claim 1, wherein the whisk means is provided with radial arms to an axial spindle, which radial arms have a curved surface to reduce drag on liquid in the frother.

8. The whisk means according to claim 1, wherein the basket can clip onto an axial spindle or alternatively be formed integrally with it so that the basket can spin in use.

9. The whisk means according to claim 3, wherein the concentric rings are spaced out more with respect to an adjacent ring closer to the centre of the whisk.

10. The whisk means according to claim 1, wherein the whisk means is provided with an upstand arranged to disrupt rotational flow of the liquid in use.

11. The whisk means according to claim 10, wherein the upstand is located adjacent to an axial spindle.

12. A hot chocolate maker comprising whisk means according to claim 1.
